(19) United States
(12) Patent Application Publication
(10) Pub. No.: US 2001/0010104 A1
(43) Pub. Date: Aug. 2, 2001

(54) Pipeline pigs

(76) Inventors: Peter Allan Couchman, Gosforth (GB); David Carl Maughan, Bedlington (GB); Peter Houldey, Chester Le Street (GB); Eric Easton, Bedlington (GB)

Correspondence Address: LARSON & TAYLOR, PLC, 1199 NORTH FAIRFAX STREET, SUITE 900, ALEXANDRIA, VA, 22314, US

(21) Appl. No.: 09/730,853

(22) Filed: Dec. 7, 2000

(30) Foreign Application Priority Data
Dec. 8, 1999 (GB) 9929060.3

(51) Int. Cl. B08B 9/055

(52) U.S. Cl. 15/104.061

(57) ABSTRACT

A pipeline pig comprises a central body member and a first drive member (26) mounted on the body member, the first drive member including a central annular support element (60) mounted on, to surround, the body member, and a plurality of circumferentially spaced primary drive elements (62) one end of each of which is secured to the support element (60) whereby the primary drive elements (62) extend substantially radially from the support element (60) and such that, in use, the other, free ends of the primary drive elements (62) engage the inner wall of the associated pipeline, each primary drive element (62) being capable of bending rearwardly of the direction of movement of the pig about the one end extent thereof to maintain engagement with the inner wall of pipelines within a range of diameters without increasing the drag thereon, the first drive member (26) further including a flexible backing disc (68) rearward of the primary drive elements (62) and adapted to seal against the inner wall of the pipeline for all bent positions of the primary drive elements (62).

### TECHNICAL FIELD

This invention relates to pipeline pigs, and has particular, though not exclusive, application to such pigs for inspecting the condition of metallic pipelines.

### BACKGROUND OF THE INVENTION

It is established practice in magnetic flux leakage inspection vehicles, hereinafter referred to as pigs, to incorporate on the front and rear of the pig polyurethane cups to provide the drive force which overcomes the magnetic drag of the pig and propels it along the pipeline. These cups are thickest at the root in order to be sufficiently stiff to support the pressure loads, the thinner outer regions of the cup flexing and sealing against the inner wall of the pipeline.

Heretofore, the pigs, and in particular the drive cups, have been dimensioned for use in a given size of pipeline. Even though the drive cups are, to a certain extent, flexible, it has been found that the loads induced when compressing or distorting a drive cup into a smaller diameter pipeline than that for which it was initially intended are too large, and result in unacceptably high drag and undue wear to the cup.

It is becoming more common for pipelines to comprise interconnected lengths of different diameters, usually joined by pipeline portions tapering from the larger diameter to the smaller diameter. Continuous inspection of such a multidiameter pipeline can thus pose problems when using pigs provided with conventional drive cups, and it has often proved necessary to utilise different pigs for the different sections of the pipeline.

### SUMMARY OF THE INVENTION

It would be desirable to be able to provide a pipeline pig incorporating a drive element capable of accommodating a range of pipeline diameters, and therefore a range of pressure loadings, whilst maintaining a relatively constant drag, and therefore wear factor, throughout said range.

According to the present invention there is provided a pipeline pig comprising a central body member and a drive member mounted on the body member, characterised in that the drive member includes a central annular support element mounted on, to surround, the body member, and a plurality of circumferentially spaced primary drive elements one end of each of which is secured to the support element whereby the primary drive elements extend substantially radially from the support element and such that, in use, the other, free ends of the primary drive elements engage the inner wall of the associated pipeline, each primary drive element being capable of bending rearwardly of the direction of movement of the pig about the one end extent thereof to maintain engagement with the inner wall of pipelines within a range of diameters without increasing the drag thereon, the drive member further including a flexible backing disc rearward of the primary drive elements and adapted to seal against the inner wall of the pipeline for all bent positions of the primary drive elements.

It will be appreciated that, with such an arrangement, the pig can be used in a variety of pipelines of different diameters within the aforesaid range, the primary drive elements bending by varying degrees about the lower end extents thereof depending upon the diameter of the pipeline in question.

In the case of larger diameter pipelines within the range, the primary drive elements extend substantially perpendicular to the centreline of the pig and are circumferentially spaced from one another with the backing disc sealing the spaces between adjacent elements as well as sealing against the inner wall of the pipeline.

In the cases of smaller diameter pipelines within the range, the primary drive elements each extend rearwardly and outwardly relative to the centreline of the pig and are, circumferentially, more closely spaced together the smaller the diameter of the pipeline, with the backing disc again sealing the pipeline rearwardly of the primary drive elements, the flexible nature of the backing disc being such as to enable sealing contact with the inner wall of the pipeline to be maintained in smaller diameter pipelines.

In a preferred embodiment of the invention, the rear surface of the one end extent of each primary drive element is recessed to provide a pivotal region of reduced thickness about which the primary drive element can bend.

Conveniently one or more support wires extend between each primary drive element and the body member, the wires being so arranged as to prevent return movement of the primary drive elements from their bent positions within a pipeline engaging the inner wall thereof when subjected to fluid pressures within the pipeline.

The drive member may further include, between the primary drive elements and the backing disc, a plurality of circumferentially spaced secondary drive elements one end of each of which is secured to the support element whereby the secondary drive elements extend substantially radially from the support element, each secondary drive element underlying the space between two adjacent primary drive elements whereby the primary and secondary drive elements combine to present a continuous front surface area to the disc member.

Preferably adjacent primary drive elements are interconnected by a retaining strap to prevent circumferential separation thereof, said strap conveniently also being secured to the secondary drive element underlying the adjacent primary drive elements.

The drive member may be mounted on a front slider itself mounted in the hollow front extent of the body member to be movable therein substantially as disclosed in our co-pending application GB 9929058.7, the content of which is incorporated herein by reference.

The pipeline pig of the invention may further include a rear drive member substantially as detailed above and secured to the rear extent of the body member.

When the rear drive member is incorporated in the pipeline pig disclosed in the aforementioned co-pending application, the pig may include a plurality of drive struts one end of each of which is pivotally mounted to the support element of the rear drive member and the other end of each of which is pivotally mounted to the rear regions of the return path elements at or adjacent the other end of an associated link arm, the drive struts being arranged so that, in the event that drive of the pig is by way of the rear drive member, the applied force from the rear drive member to the return path elements has a substantial component in the axial direction of the pig.

### BRIEF DESCRIPTION OF THE DRAWINGS

FIG. 1 is a longitudinal section through a pig according to the invention located in a first pipeline;

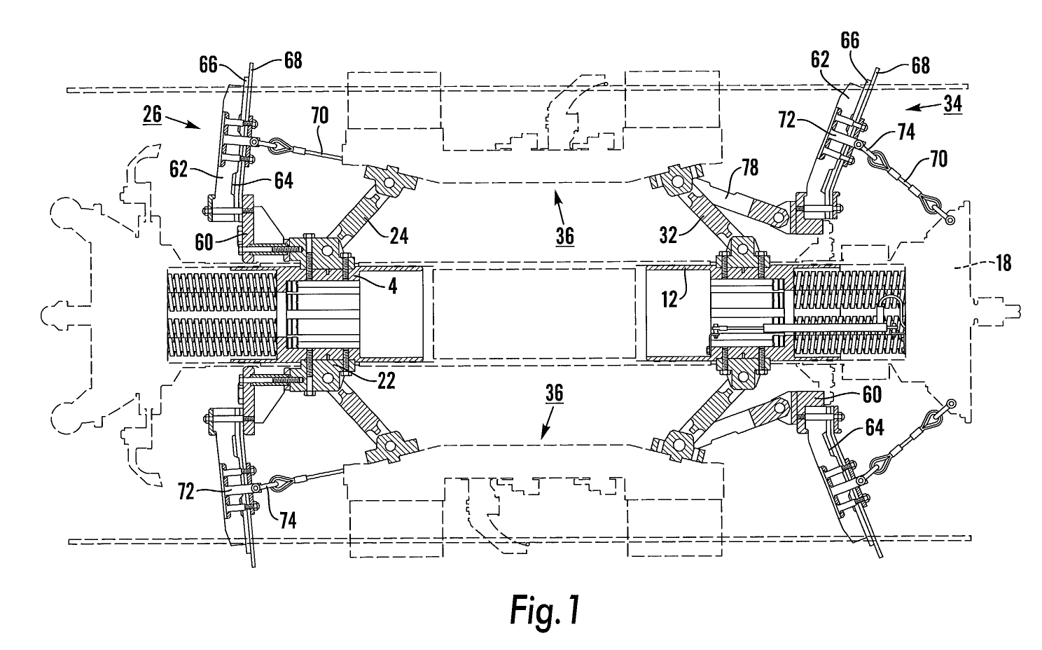

FIG. 2 is a longitudinal section through the pig of FIG. 1 located in a second pipeline of smaller diameter than the first;

FIG. 3 is a longitudinal section through the pig of FIGS. 1 and 2 in a tapering pipeline;

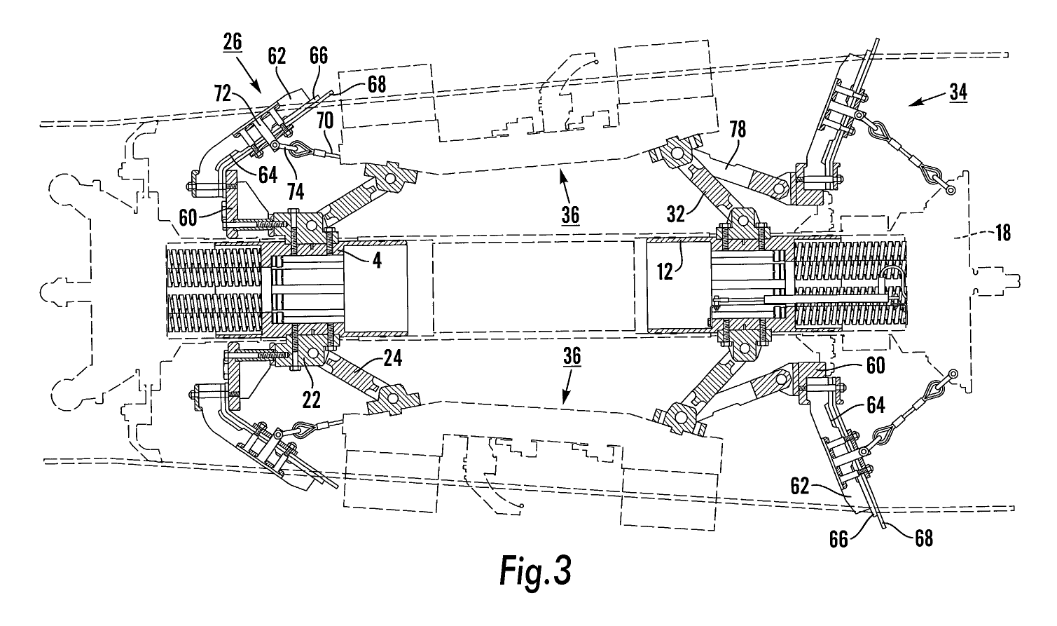

FIG. 4 is a front view in the direction of arrow A in FIG. 1 of the drive member of the pig of FIGS. 1 to 3, and

FIG. 5 is a rear view in the direction of arrow B in FIG. 1 of the drive member of the pig of FIGS. 1 to 3.

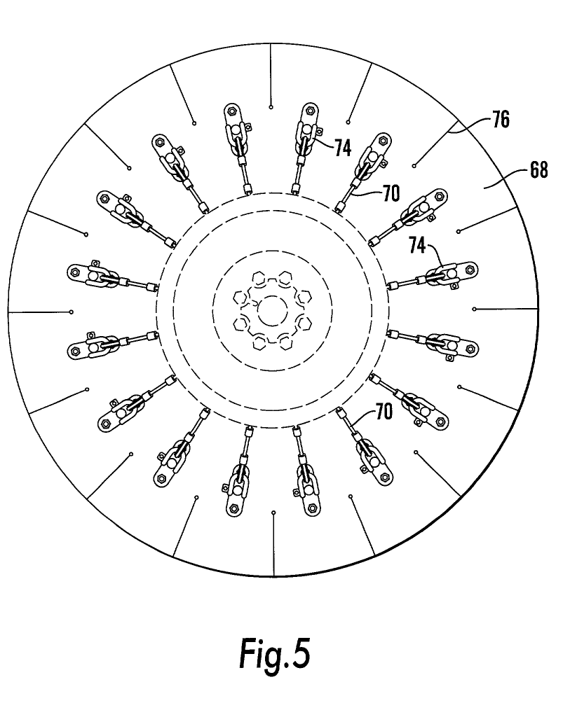

### DESCRIPTION OF The PREFERRED EMBODIMENTS

Referring to the drawings, the illustrated pipeline pig is substantially as disclosed and described in our co-pending application referred to above, and incorporates return path elements 36 the front and rear ends of which are constrained to maintain-circular configurations of variable diameters in the manner of umbrella type mechanisms by means of resiliently biased front and rear sliders 4, 12 and front and rear sets of pivotal link arms 24, 32.

Such an arrangement enables a given pig to be used in pipelines with a variety of diameters within a given range with the return path elements maintaining engagement with the inner wall of the pipeline regardless of the diameter of the pipeline within that range.

The present invention ensures that the front and rear drive members 26 and 34 also maintain sealing engagement with the inner wall of the pipeline regardless of the diameter of the pipeline within that range, and without increasing the drag factor in smaller pipeline diameters.

More particularly, and referring to the front drive member 26, said drive member 26 comprises a central annular support element 60 bolted to the front slider 4 by way of the link blocks 22. A plurality of primary drive elements 62, each of generally block shape and of substantial thickness, are circumferentially spaced around the drive member 26 with one end of each element 62 bolted to the support element 60 to extend radially therefrom.

The primary drive elements 62 are typically of polyurethane, the rear surfaces of the one end extents of the elements 62 being recessed at 64 to provide reduced thickness regions about which the elements can bend as will be detailed below.

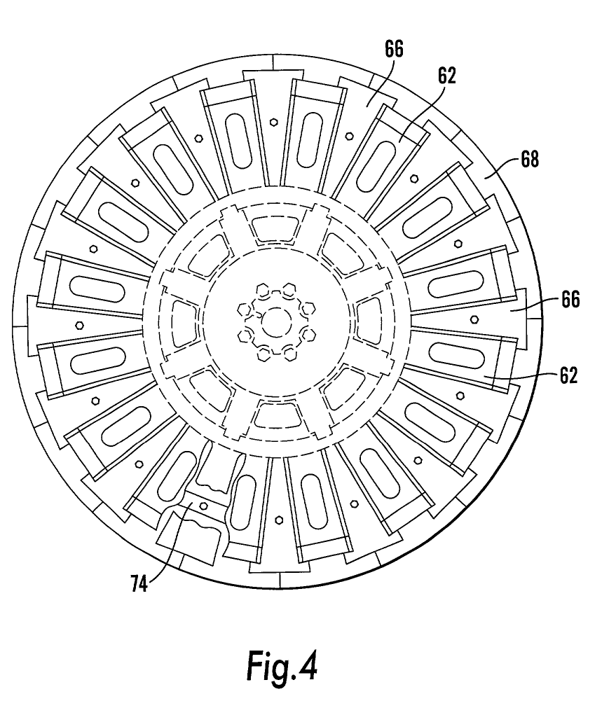

Rearwardly of the primary drive elements 62 there are provided a corresponding plurality of secondary drive elements 66 of a polyurethane material thinner than that of the drive elements 62, one end of each drive element 66 being secured to the support element 60 to extend radially outwardly therefrom, each secondary drive element 66 underlying the space between an adjacent pair of primary drive elements 62 as clearly seen in FIG. 4.

The laminated construction of the drive member 26 is completed by a thin, flexible annular backing disc 68 positioned rearward of the secondary drive elements 66 and also bolted to the support element 60.

One end of a wire rope 70 is secured to each of the primary drive elements 62, the other end of the rope 70 being secured to an associated return path element 36 of the pipeline pig. More particularly, a bracket assembly 72 mounted to the rear of each drive element 62 extends from the element 62 between the adjacent secondary drive elements 66 and through the backing disc 68 with the backing disc 68 secured thereto, the one end of the rope 70 being attached to the bracket assembly 72 by means of a link 74.

In use, the drive elements 62 of the drive member 26 can bend about the regions of reduced thickness created by the recesses 64 whereby the free ends thereof are located to engage the inner wall of the pipeline regardless of the diameter of the pipeline within the given range. The materials of the secondary drive elements 66 and the backing disc 68 are such that they are readily capable of bending with the primary drive elements 62. The overall construction of the drive member 26, and in particular the controlled folding of the primary drive elements 62, is such that the drag factor of the member 26 in the pipeline is substantially constant for all diameters of pipelines. The flexible and thin nature of the backing disc 68 is such as to ensure that, even in smaller diameter pipelines where multiple folding of the peripheral regions of the bent disc 68 occurs, sealing engagement with the inner wall of the pipeline is maintained.

Once the drive member 26 is bent to the position appropriate to the diameter of pipeline under inspection, the wire ropes 70 support the primary drive elements 62 and prevent their attempted unbending on the application thereto of the driving force. More particularly, the attachment of the ropes 70 to the return path elements 36, and the movable nature of the return path elements 36 in accordance with the diameter of the pipeline, are such as to ensure that the ropes 70 remain taut in all pipeline diameters within the range.

Furthermore, the attachment of the ropes 70 to the return path elements 36, which are the drag inducing parts of the pig has the additional advantage of ensuring that the towing force applied by the drive member 26 to the return path elements 36 by way of the wire ropes 70 is in an efficient direction and pulls the elements 36 substantially forwards.

It is however to be emphasised that the described drive member 26 may be incorporated in a pig with return path elements other than those illustrated, with the wire ropes 70 secured to other parts of the pig body and maintained taut other than by positioning of the return path elements.

Conveniently adjacent primary drive elements 62 are interconnected with one another by a strap 74 to prevent the circumferential spacing therebetween exceeding that associated with the maximum diameter pipeline within the range and shown in FIG. 4. Preferably the strap 74 connecting two primary drive elements 62 is also secured to the underlying secondary drive element 66 therebetween which can slide relative to the associated primary drive elements 62 on bending thereof.

The backing disc 68 may incorporate a series of radially extending slits 76 in the outer regions thereof to facilitate the maintenance of sealing contact with the inner wall in smaller diameter pipelines.

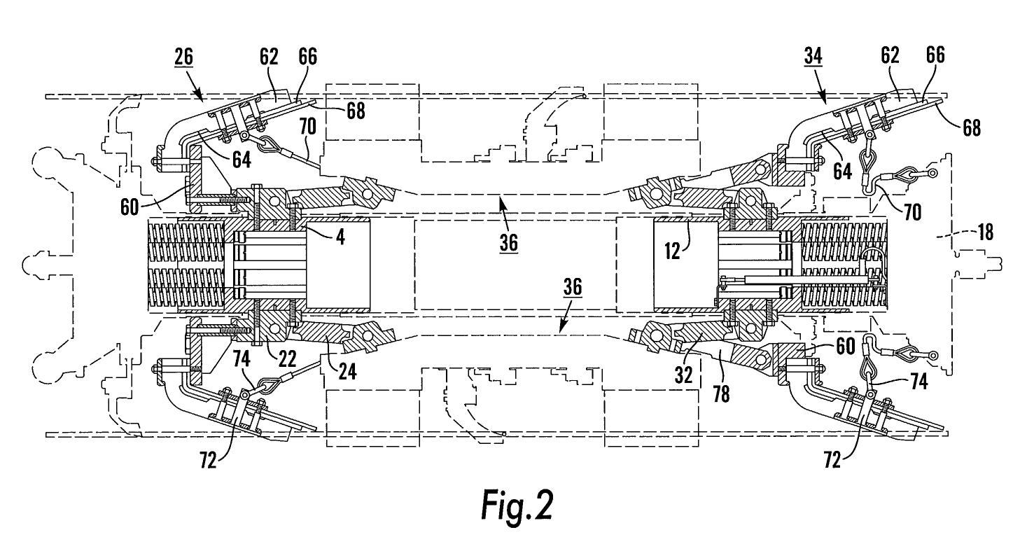

The rear drive member 34 is of the same construction as the front drive member 26, although the central annular support element 60 thereof is secured directly to the body 2 of the pig, while the other end of each wire rope 70 is also attached to the fixed rear end member 18 of the pig. The wire ropes 70 are taut when the drive member 34 is positioned in the largest diameter pipeline to be inspected by the pig, but, as seen in FIG. 2, becomes slack in smaller diameter pipelines.

The rear drive member 34 is only used when, for example, passing off-takes and the like which periodically and temporarily eliminate drive from the front drive member 26. In the case of rear drive, a plurality of low angle struts 78 pivotally connected between the rear support element 60 and the connections of the link arms 32 with the rear regions of the return path elements 36 serve to transmit the forces from the drive member 34 to the return path elements 36. The ideal direction of push from the member 34 to the elements 36 would be along the axis of the pipe, and the struts 78 get as close to this as is practically possible and are sufficient to negate the possibility of a stuck pig.

We claim:

1. A pipeline pig for a pipeline having an inner wall, the pig comprising a central body member, a first drive member mounted on the body member, the first drive member including a central annular support element mounted on, to surround, the body member, and a plurality of circumferentially spaced primary drive elements each having a one end and a free end, the one end of each of which is secured to the support element whereby the primary drive elements extend substantially radially from the support element and such that, in use, the free ends of the primary drive elements engage the inner wall of the associated pipeline, each primary drive element being capable of bending rearwardly of the direction of movement of the pig about the one end extent thereof to maintain engagement with the inner wall of pipelines within a range of diameters without increasing the drag thereon, the first drive member further including a flexible backing disc rearward of the primary drive elements and adapted to seal against the inner wall of the pipeline for all bent positions of the primary drive elements.

2. A pipeline pig as claimed in claim 1 in which the rear surface of the one end extent of each primary drive element is recessed to provide a pivotal region of reduced thickness about which the primary drive element can bend.

3. A pipeline pig as claimed in claim 1 in which at least one support wire extends between each primary drive element and the body member, the wires being so arranged as to prevent return movement of the primary drive elements from their bent positions within a pipeline engaging the inner wall thereof when subjected to fluid pressures within the pipeline.

4. A pipeline pig as claimed in claim 1 in which the first drive member further includes, between the primary drive elements and the backing disc, a plurality of circumferentially spaced secondary drive elements one end of each of which is secured to the support element whereby the secondary drive elements extend substantially radially from the support element, each secondary drive element underlying the space between two adjacent primary drive elements whereby the primary and secondary drive elements combine to present a continuous front surface area to the first drive member.

5. A pipeline pig as claimed in claim 4 in which adjacent primary drive elements are interconnected by a retaining strap to prevent circumferential separation thereof.

6. A pipeline pig as claimed in claim 5 in which the retaining strap is also secured to the secondary drive element underlying the adjacent primary drive elements.

7. A pipeline pig as claimed in claim 1 in which the first drive member is mounted on a front carrier member itself mounted in the hollow front extent of the body member to be slidable therein.

8. A pipeline pig as claimed in claim 1 and further comprising a second drive member secured to the rear extent of the body member, the second drive member including a central annular support element mounted on, to surround, the body member, and a plurality of circumferentially spaced primary drive elements each having a one end and a free end, the one end of each of which is secured to the support element whereby the primary drive elements extend substantially radially from the support element and such that, in use, the free ends of the primary drive elements engage the inner wall of the associated pipeline, each primary drive element being capable of bending rearwardly of the direction of movement of the pig about the one end extent thereof to maintain engagement with the inner wall of pipelines within a range of diameters without increasing the drag thereon, the second drive member further including a flexible backing disc rearward of the primary drive elements and adapted to seal against the inner wall of the pipeline for all bent positions of the primary drive elements.

9. A pipeline pig as claimed in claim 8 and including a plurality of circumferentially spaced return path elements surrounding the body member and each extending axially relative to the body member, each return path element including a pair of axially spaced magnets from each of which projects a metallic bristle set, means for connecting the return path elements to the body member whereby the free ends of the bristles, in use, resiliently engage the inner wall of the pipeline, said connecting means comprising a first carrier member mounted on, to be axially slidable relative to, the front extent of the body member and resiliently urged towards the rear of the body member, the first drive member being mounted on said first carrier member, a second carrier member mounted on, to be axially slidable relative to, the rear extent of the body member and resiliently urged towards the front of the body member, and, for each return path element, a front link pivotally interconnecting the front of the return path element and the first carrier member and a rear link pivotally interconnecting the rear of the return path element and the second carrier member, and a plurality of drive struts each having a one end and an other end, the one end of each of which is pivotally mounted to the support element of the second drive member and the other end of each of which is pivotally mounted to the rear regions of the return path elements at or adjacent the other end of an associated link, the drive struts being arranged so that, in the event that drive of the pig is by way of the second drive member, the applied force from the second drive member to the return path elements has a substantial component in the axial direction of the pig.
